(19) United States
(12) Patent Application Publication
(10) Pub. No.: US 2026/0030575 A1
(43) Pub. Date: Jan. 29, 2026

(54) WORK SPACE AVAILABILITY STATUS IDENTIFICATION

(71) Applicant: Lenovo Global Technology (United States) Inc., Morrisville, NC (US)

(72) Inventors: Mark Delaney, Raleigh, NC (US); John C. Mese, Cary, NC (US); Nathan Peterson, Oxford, NC (US)

(21) Appl. No.: 18/785,931

(22) Filed: Jul. 26, 2024

(51) Int. Cl. G06Q 10/0631

(52) U.S. Cl. CPC G06Q 10/06314

(57) ABSTRACT

One embodiment provides a method, the method including: identifying, from a scheduling application, a scheduling status of at least one work space within a physical space; detecting, utilizing sensors within the physical space, a physical presence of users at the at least one work space; identifying, based upon the scheduling status and the physical presence, an availability status of each of the at least one work space; and displaying, on a display device, the availability status of each of the at least a subset of the at least one work space. Other aspects are claimed and described.

### BACKGROUND

Many companies or other entities utilize different work place environments. Some places utilize traditional cubicle or office space environments that have walls or partitions separating individuals from each other. These spaces may also have conference rooms where individuals can meet together in the same space. While such work place environments may assist in allowing users to focus and complete tasks without the distraction of other people, these environments may not readily foster collaboration between users. Other work place environments may be an open space environment that includes desks, tables, or other large work spaces that many users sit at next to each other without the inclusion of a partition or other wall. Such work environments may more readily foster collaboration between users and, particularly, between people working on the same team, within the same group, or on the same project. However, without the partitions, some users may find it difficult to focus or find a space to conduct private conversations or conduct conversations that may be distracting to other users. Thus, another type of work place environment may provide a combination of traditional cubicle or office work spaces and open work spaces, thereby allowing users to select the best work space for the desired task.

### BRIEF SUMMARY

In summary, one aspect provides a method, the method including: identifying, from a scheduling application, a scheduling status of at least one work space within a physical space; detecting, utilizing sensors within the physical space, a physical presence of users at the at least one work space; identifying, based upon the scheduling status and the physical presence, an availability status of each of the at least one work space; and transmitting an instruction to display, on the display device, on a display device, the availability status of each of the at least a subset of the at least one work space.

Another aspect provides a system, the system including: sensors within a physical space; a display device; a processor operatively coupled to the sensors and the display device; a memory device that stores instructions that, when executed by the processor, causes the system to: identify, from a scheduling application, a scheduling status of at least one work space within the physical space; detect, utilizing the sensors within the physical space, a physical presence of users at the at least one work space; identify, based upon the scheduling status and the physical presence, an availability status of each of the at least one work space; and transmit an instruction to display, on the display device, on the display device, the availability status of each of the at least a subset of the at least one work space.

A further aspect provides a product, the product including: a computer-readable storage device that stores executable code that, when executed by a processor, causes the product to: identify, from a scheduling application, a scheduling status of at least one work space within the physical space; detect, utilizing sensors within the physical space, a physical presence of users at the at least one work space; identify, based upon the scheduling status and the physical presence, an availability status of each of the at least one work space; and transmit an instruction to display, on the display device, on a display device, the availability status of each of the at least a subset of the at least one work space.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for identifying an availability status of a work space based upon a scheduling status and a physical presence of users at the work space.

FIG. 4 illustrates an example overlay of an availability status for work spaces within a physical space.

### DETAILED DESCRIPTION

Regardless of the type of work place environment, with the increase in the number of users who work from remote locations or who may not be in the physical space every day, many work places are forgoing traditional desk or work space assignments. Instead of assigning a particular work space to a user, users who are within the physical space at a particular time instead find an open work space that meets the needs of the user and utilizes that space. However, this first-come, first-served work space utilization can result in multiple problems. First, users may claim a work space and find it taken by someone else if they step away for a short period of time. Second, some work spaces may have different capabilities as compared to other work spaces. Thus, a user needing certain capabilities may not be able to find a usable work space if all of these work spaces are taken. Another problem is that users who are working on the same project or who would like to work together in the same space may be unable to find enough open work spaces together that allows the users to sit together. There are other problems with this technique.

A solution to these problems has been to allow for users to book a particular space or spaces through a virtual booking agent or calendar application. This allows users to book work spaces that have the desired capabilities and also allows users to book work spaces that allow a group of users to sit together. A problem with this is that when a person walks into a physical space, the person cannot tell which work spaces have been virtually booked. Instead, the user has to pull up the virtual booking application to tell which spaces have been virtually booked. Additionally, a user may virtually book a work space and then never show up to the physical space. Thus, the work space is never utilized. Even if a work space is virtually booked, a user who walks into a space cannot tell if the work space is actually being utilized. In other words, the user is unable to tell if the person who virtually booked the space has actually been using the space unless the person is sitting within the space or has left stuff within the space. Therefore, because users may virtually book a space but then not actually use the space, the people who need a work space are left with the same problem that occurs without the virtual booking application.

Accordingly, the described system and method provides a technique for identifying an availability status of a work space based upon a scheduling status and a physical presence of users at the work space. The system can identify a scheduling status of one or more work spaces within a physical space. Identifying the scheduling status may include accessing a virtual booking agent or calendar application that identifies a virtual booking status of the work space(s). The system utilizes sensors to detect a physical presence of users at any point during a day. In other words, the sensors are not utilized to only detect a physical presence of users at a particular time, but rather continuously detect a physical presence of users. This allows the system to determine not only if users are at a particular work space, but when users were last detected at a particular work space.

Based upon the scheduling status of the work space(s) and the detected physical presence of users at the work space(s), the system can identify an availability status of each work space within a physical space. For example, the system can identify if a work space is virtually booked and also if and when a physical presence was last detected at the work space. Using this information, the system can determine which work space may be most likely to be unused and which work space is likely to be the best option for the user to utilize. The system may also identify multiple work spaces which may be options and identify the virtual booking status and physical presence information for the user. The availability status and information related to the availability status may be displayed to the user. As an example, the availability status information may be overlaid on a visualization of the physical space. For example, if the user is utilizing an augmented reality headset, the availability status may be overlaid on the augmented reality headset. As another example, the availability status may be overlaid on a two-dimensional map, three-dimensional model, and/or the like, of the physical space that is accessible via a smart phone, tablet, laptop computer, on a display or monitor within the physical space, and/or any type of information handling device or display.

Therefore, a system provides a technical improvement over traditional methods for identifying a work space that is available for use. The described system provides a technique for saving a work space that is not possible with traditional methods that do not have at least a virtual booking system. The described system provides an improvement over the virtual booking systems by not only relying on virtual bookings which may be inaccurate or unfulfilled, but also relies on sensors within the physical space to detect the presence of users at a work space. Thus, the availability status provided by the system not only identifies if the work space is booked, but also identifies whether the work space has actually been used during that booking. Accordingly, the system provides a more accurate identification of whether a work space might be available for a person walking into a space than the traditional virtual booking technique. The described system is, therefore, more accurate, provides for better work space identification, and more user friendly than traditional work space identification techniques.

The illustrated example embodiments will be best understood by reference to the figures. The following description is intended only by way of example, and simply illustrates certain example embodiments.

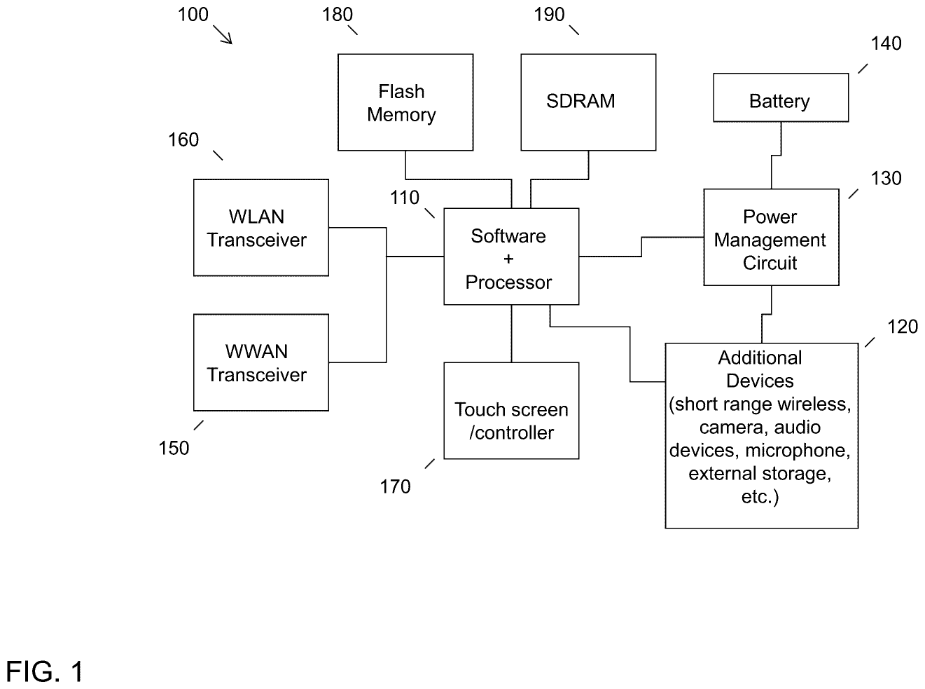

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

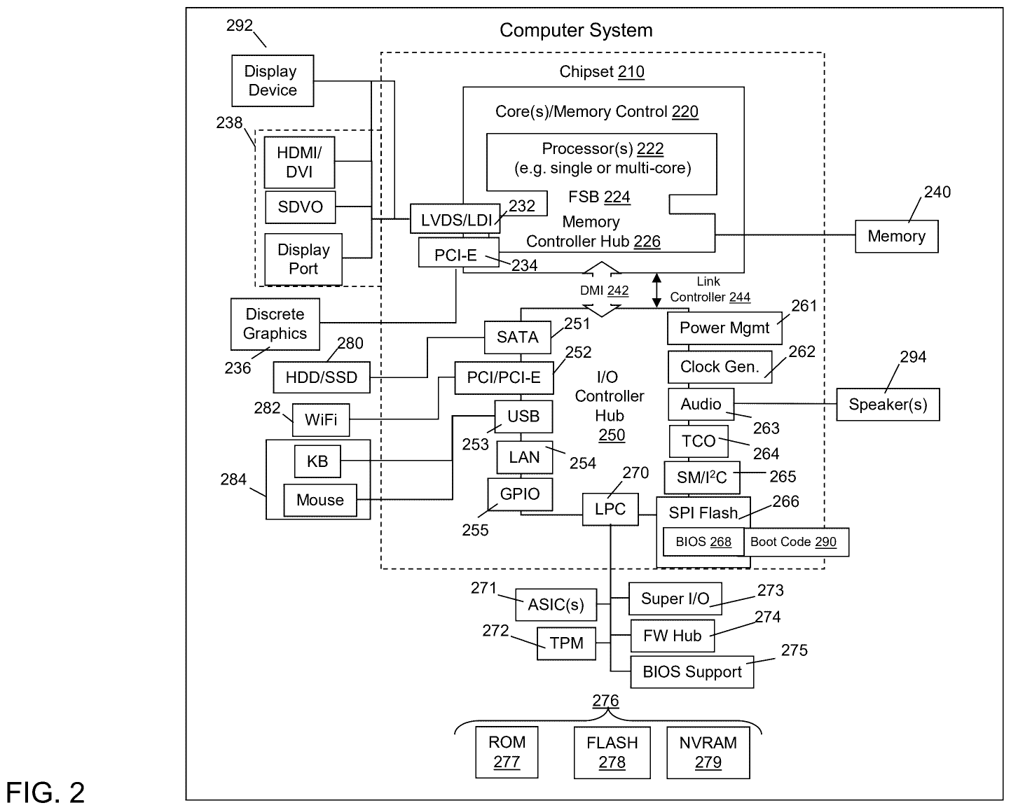

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used within devices that provide a scheduling system to schedule work spaces, detect a physical presence of users at work spaces, identify an availability status, and display an availability status. For example, the circuitry outlined in FIG. 1 may be implemented in a tablet or smart phone embodiment, whereas the circuitry outlined in FIG. 2 may be implemented in a personal computer embodiment.

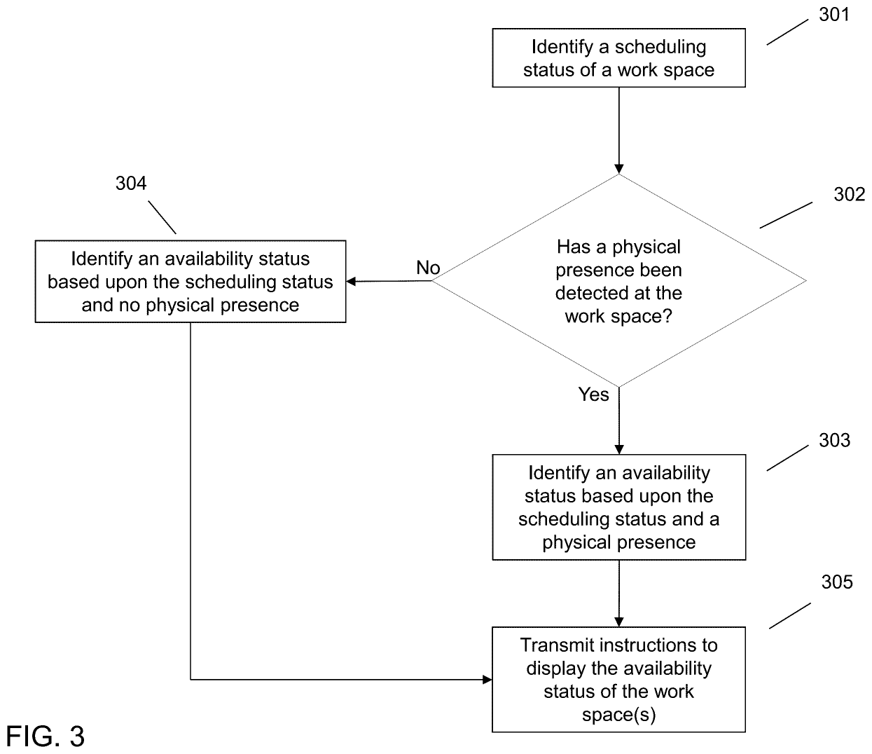

FIG. 3 illustrates an example method for identifying an availability status of a work space based upon a scheduling status and a physical presence of users at the work space. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to identify and display an availability status of a work space within a physical space. Additionally, the work space availability system includes modules and features that are unique to the described system.

The system may be automatically activated by an application that provides instructions to the system or may be manually activated by a user providing input to the system. The automatic activation of the work space availability system may be based upon the detection of a trigger event indicating that the system should be activated. Example trigger events include detection of a user entering a physical space, a user accessing a scheduling or calendar system, activation of software or an application utilizing the work space availability system, and/or the like.

The work space availability system may be made of multiple systems or modules that communicate together to make up the work space availability system or may be a single system. The work space availability system may be a standalone system, may be accessible through other computing devices, and/or a combination thereof. For example, the work space availability system may be a standalone system that can be accessed by a user and/or may be or provide an application that is accessible by a user on another computing device. The work space availability system may be accessible using any type of computing device, for example, personal computer, laptop computer, smartphone, tablet, smartwatch, head-mounted display, smart television or other smart appliance, augmented reality device, virtual reality device, and/or the like. Thus, the work space availability system may be accessible locally using a computing device where the work space availability system is installed and/or may be accessible remotely through another computing device. For example, the work space availability system may be accessed by a user using a device that communicates with the work space availability system to provide instructions for activating or deactivating locks on devices, verifying the lock status of a device, and/or the like. However, the work space availability system may be located and operate on a different information handling device to perform the described steps.

The work space availability system may have an associated graphical user interface. The graphical user interface may be provided on a display or monitor, which may or may not be associated with the work space availability system. In other words, the work space availability system may have a dedicated display or monitor or may be accessible using any display or monitor. In either case, the work space availability system may provide instructions to generate and display the graphical user interface on the display device being used to access the work space availability system. The graphical user interface may also be updated and managed based upon instructions provided by the work space availability system. In other words, the work space availability system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the work space availability system. For example, the work space availability system may utilize a user profile, work space or physical space profile, historical information, schedule information, device information, calendar or schedule application, and/or the like, to identify a work space for a user, identify a status of a work space, and identify an availability status of work spaces. The graphical user interface may allow for creation of or access to these profiles, historical information, or work space scheduling information by allowing a user to input information regarding the work spaces, user, schedule, and/or the like. As will be discussed in more detail, the use of user provided information is not the only way that the profile, historical information, and/or work space scheduling information can be created. The work space availability system can then utilize these inputs to create the profile(s), store the historical information, identify a work space availability status, and/or the like.

A user could also use the graphical user interface to adjust information within the profile(s), access or adjust historical information, identify a work space for use, provide input indicating that a work space should be identified, and/or the like. Additionally, or alternatively, the user can input a location of information related to one or more of the profiles, historical information, work space information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, display the work space availability information and other information related to the work space, display the preferences or information utilized in recommending a work space, and/or the like. It should be noted that the information to be used by the work space availability system and information provided by the work space availability system can be different for different applications, different computing systems, different users, and/or the like. Thus, the information corresponding to input or output of the work space availability system are not always the same. However, the work space availability system may have default or system-wide settings that are the same across different users, systems, applications, and/or the like, until the information is adjusted or otherwise changed.

It should be noted that different users may configure the graphical user interface according to their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The work space availability system may utilize one or more artificial intelligence models in identifying an availability status of a work space, detecting a physical presence of a user at a work space, identifying a scheduling status, and/or any other steps included in the system or method. Artificial intelligence models may also be used for steps within a step. For example, a model could be utilized to analyze a physical presence of users at a work space to assist in determining if the user may return to a work space when identifying the availability status of a work space, analyze a detected physical presence of a user against a scheduling status for a work space to identify the availability status of a work space, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the work space availability system or may be a model that is created from scratch. Since the work space availability system is used in conjunction with identifying an availability status of a work space, some models that may be utilized by the system are image analysis models, sensor information analysis models, similarity identification models, language models, large language models, filtering models, classification models, and/or the like. The model may be trained using one or more training datasets. Additionally, as the model is deployed, it may receive feedback to become more accurate over time. The feedback may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model ingests this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The work space availability system may include different components for carrying out different functions of the system, including different steps to be performed. These components may be hardware components or software components. One software component that may be utilized is a user profile. Within the user profile, the user may set preferences for one or more physical spaces. For example, if a user accesses more than one physical space, the user can set the user profile for each of the physical spaces. The user may also set general preferences that can be utilized for any physical space and then set specific preferences for specific physical spaces. The user profile may identify work space preferences of the user, which may include locations of the work spaces, capabilities of the work spaces, and/or the like. For example, the user profile may identify certain equipment that the user may need/want (e.g., a number of monitors, access to a printer, a particular type of keyboard, a particular type of chair or work space (e.g., desk, table, no surface, etc.), monitor or display capabilities (e.g., touch screen, wide screen, high resolution, etc.), network capabilities, etc.). As another example, the user profile may identify a preferred location of a work space (e.g., away from other users, near certain users, near a printer or other amenity, in a meeting room, in a location to carry on conversations or meetings, near an entrance or exit, etc.). Thus, the user profile can identify any type of preference that the user may have.

The user profile may also identify an importance of a particular preference or capability. The importance can then be utilized to filter or recommend particular work spaces for a user. For example, if a user needs a particular capability and prefers a particular location, the capability may be identified as required and the location may be identified as requested when the system is making recommendations for work spaces to the user or identifying a work space availability. The importance can also be used as a weighting when identifying or displaying the work space availability. For example, preferences or capabilities that are identified as more important than other preferences or capabilities may be weighted more highly when the system is attempting to identify a work space or recommend work spaces for the user.

The user profile may also identify schedules of a user, for example, when a user may be within a particular physical space, what capabilities may be needed at a particular time, who the user is meeting or working with at particular times or days, and/or the like. This information may be utilized by the system to determine when a user might need a work space and where the user might need a work space. It may also be utilized to identify the capabilities or preferences that a user might have at different times. For example, a user may have meetings scheduled for a particular day as per the user's calendar, so the system can determine that the user needs a meeting room or does not need a work space because the user is going to be in a meeting room scheduled for a different user. As another example, a user may have tasks scheduled that require a particular capability, for example, a printer, so the system may utilize the schedule to identify work spaces that include the capability that is required by the task.

Another software component that may be utilized is a work space or physical space profile. The work space or physical space profile may identify the work spaces within the physical space including, but not limited to, a number of work spaces, a type of work spaces, a location of work spaces in the physical space, and/or the like. Additionally, the work space or physical space profile may identify information regarding the capabilities of a work space, for example, a number of monitors, peripherals that are located at a particular space, peripherals and/or amenities that are located near a particular space, network connections available at a particular location, the types of chairs at the work space (e.g., bench, office chair, wooden chair, couch, cushioned chair, etc.), a type of work surface at the work space (e.g., desk, table, circular table, rectangular table, etc.), a grouping of work spaces or how many work spaces are clustered together, a type of the work space (e.g., open desk or table, a meeting room, a cubicle, an office, etc.), and/or the like. Additionally, the work space or physical space profile may include information related to the physical space, for example, a location of amenities (e.g., break room, printer area, shred bins, etc.), a location of entrances and exits, a location of stairs and elevators, and/or the like. Thus, the work space or physical space profile may include any information related to the physical space or work space that could be utilized to assist in determining a work space for a user.

Another software component that may be utilized by the system is a database or other data storage location where the system can store historical information regarding work spaces and information associated with the work spaces and users within the work spaces. The information stored within the data storage location may be stored within a single data lake or data storage location or may be separate data lakes or data storage locations that may be divided by users, work spaces, and/or the like. For example, each user may have their own data storage location and any historical information related to the at user will be stored within the data storage location of the user. The historical information can be utilized by the system to respond to queries by users that might be related to the historical information. For example, the system may utilize the historical information to respond to queries by users regarding who was in a meeting or group, what information was discussed on a particular day or time, what location was used at a particular day or time, and/or the like. Thus, not only can the system provide information related to work space availability, but can also use the information captured by the sensors to respond to queries regarding historical information.

Some hardware devices that may be utilized by the work space availability system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the work space availability system. For example, the work space availability system may include speakers, displays or monitors, haptic output devices, audio output devices, and/or the like. Other hardware components may be included on a device having the work space availability application or access to the work space availability system and information from these components may be utilized by the work space availability system. For example, the device may include proximity sensors, image capture devices, audio capture devices, audio output devices, display devices, infrared sensors, ultrasonic sensors, radiofrequency sensors, biometric sensors, input devices, and/or the like.

Sensors may also be included in the physical space or within or near work spaces. These sensors may assist in determining a physical presence of a user at a work space. Thus, the sensors may include, but are not limited to, ultrasonic sensors, infrared sensor, radiofrequency sensors, proximity sensors, image capture sensors/devices, audio capture sensors/devices, near field communication sensors/devices, motion detection sensors, and/or the like. Some sensors can be utilized to detect the presence of users and some sensors can be utilized to detect a particular location of a user within a physical space. Some sensors may have the ability or provide information that can be utilized to identify both that a user is within a space and the location of the user within the space. Infrared sensors detect the presence of objects or users by measuring the amount of infrared radiation that is emitted or reflected. Ultrasonic sensors use sound waves to detect the distance of objects or users by measuring the time it takes for the sound waves to bounce back. Radiofrequency sensors detect the presence of objects or users by emitting radio waves and measuring the amount of energy that is reflected back.

Proximity sensors can be utilized to detect if a user is within proximity to the sensor. If the sensor is in a work space, then a user in proximity to the sensor would indicate that the user is within proximity to or utilizing the work space. Similarly, near field communication sensors, short range communication sensors, network signal sensors, and/or the like, can be utilized to detect devices in range of the sensors. If these devices are assigned to or identifiable as belonging to a user, the system can determine that a user is within a particular proximity to the sensor. Using information identifying the location of these sensors, this information can be utilized to identify that a user is within proximity to a work space or at a work space.

Image capture devices/sensors can be utilized to detect user within the physical space or the viewing field of the image capture device. The system could use an image analysis technique and/or artificial intelligence model(s) to identify users and locations of users within the image(s). The images and image analysis can also be utilized to determine when a user or group of users might be leaving a work space. For example, captured video images may be analyzed and identify that users are packing up and are therefore likely to be leaving a work space. As another example, captured video images may be analyzed and identify that even though a work space is only scheduled for another four minutes, the images indicate that the user is not performing any actions that would indicate the user is leaving the work space in the next four minutes.

Audio capture sensors/devices can be utilized in a similar manner to the image capture devices/sensors. The audio capture sensors can capture audio information that can then be analyzed using an audio analysis technique and/or artificial intelligence model to identify particular audio within the captured audio, for example, user voices, words said by users, and/or the like. Identification of user voices can be utilized to identify that a user is within a particular proximity to the audio capture device. Words said by users can be parsed and analyzed to identify words that may indicate a status of users at a work space. For example, when users are finishing up a meeting, they may say things that are indicative of the meeting ending, for example, “any questions,” “thanks for joining everyone,” “goodbye,” and/or the like. Similarly, when a user is leaving a work space they may say goodbye to other users in the area, tell someone they are leaving, and/or the like. Similarly, parsing the audio may indicate that the user is not ready to leave, that a meeting is not going to be over in a particular time frame, and/or the like. Thus, both images and audio can be analyzed and parsed to identify indicators that would indicate that a user is soon to leave a work space or is not yet ready to leave a work space, thereby allowing the system to determine an availability of a work space.

At 301, the work space availability system may identify, from a scheduling application, a scheduling status of at least one work space within a physical space. A scheduling application may be any type of application that can be utilized to identify a virtual booking status of a work space. Thus, the scheduling application may include a calendar application associated with the physical space, a virtual booking agent application, a calendar application associated with a user or work space, and/or the like. The scheduling application may include the schedule status information related to the physical space, for example, virtual reservation status, reservation records, and/or the like, of the work spaces within the physical space. To identify the scheduling status, the system may access the scheduling application and pull scheduling information from the scheduling application. The scheduling status identifies whether a work space has been virtually scheduled for a particular day and time. The scheduling status may identify different information regarding the virtual booking of the work space. For example, the scheduling status may identify the times, days, lengths of time, users who created the booking, a number of users for which the booking is made, a reoccurrence of a booking, a frequency of bookings for a particular work space, and/or the like, for the work space.

The system, from the scheduling status, may also identify how likely it is that a user will actually use the physical space that has been booked. For example, some users may virtually book or schedule a work space, but then may not actually enter the physical space and physically use the work space. As another example, some users may always use work spaces that they have virtually booked or scheduled. Thus, using historical information regarding work spaces and bookings of those work spaces, the system can calculate a confidence score related to how likely it is that a virtually booked work space will actually physically be used during that scheduled time. In other words, the system can perform a likeliness of use calculation for a particular work space. This likeliness of use calculation can then be utilized by the system to identify the availability status of the work space. The likeliness of use calculation may be calculated using one or more algorithms and/or may be calculated using an artificial intelligence model. The model can also be utilized to supplement the algorithms when performing the calculation and/or increase a confidence of the output of the algorithms. It should be understood that a user who virtually books a work space and then generally actually physically utilizes that work space during the booked time would result in a higher likeliness of use score as compared to a user who virtually books a work space and then generally does not physically utilize that work space during the booked time.

Other factors can be accounted for during the likeliness of use calculation. For example, the system may identify trends or factors that influence the use of a virtually booked work space. Such trends or factors may include whether the booking includes other users, the location of the work space, how soon before use the work space was booked, whether the user was in the physical space at the time of the scheduling, what was the weather at the time of the booking versus the time of use, and/or the like. In other words, the system may identify factors that influence whether a user actually physically utilizes a virtually booked work space. These factors can then be taken into account when performing the likeliness of use calculation. The likeliness of use calculation can be performed for individual users, individual work spaces, a physical space, and/or the like.

At 302, the system may determine if a physical presence has been detected at the work space. In other words, the system detects a physical presence of users at the work space. To detect the physical presence of users, the system utilizes sensors within the physical space. Such sensors include those previously discussed. Detecting a physical presence at a work space does not include only detecting a current physical presence at the work space, but also include identifying when the last physical presence at the work space was detected. In other words, the system keeps track of when a physical presence has been detected at a work space so that the system can identify not only if a person is currently at the work space, but when a person was last at the work space. This may assist the system in determining a likeliness that a user will return to the work space. Accordingly, the system may calculate a likeliness to return score for the work space, which can assist in determining the availability of the work space for a new user entering the physical space or attempting to virtually book a work space. The system may also identify that if the user is likely to return, how long before the user is likely to return to the work space.

In calculating a likeliness to return score for the work space, the system may also identify the identity of a person who is detected at the work space. Identifying the particular person can help the system in determining if the person is likely to return to the space. The system can access historical information regarding the user that may assist in performing the likeliness to return score. For example, some users may take breaks at particular times or during particular time ranges, but then return to a work space, thereby increasing a likeliness to return score if the user has left a work space at a similar time. As another example, some users may never return to a work space once they have left the work space, thereby decreasing a likeliness to return score if the user has left the work space.

Additionally, by identifying the particular person, the system can access secondary sources related to the person to identify factors that may influence whether that user will return to the work space. For example, the system could access a calendar of the user. If the calendar indicates that the user has a meeting when the user left the work space, this information can influence the likeliness to return score and may also assist in determining how long before the user returns. As another example, the system could access captured audio information of the user while at the work space and identify that the user indicated they were going to return or not return to the work space.

Like the likeliness to use calculation, the likeliness to return calculation can account for different factors or trends that may influence the likeliness to return calculation. These factors and trends may be similar factors or trends that can be utilized in performing the likeliness to use calculation. Additionally, the likeliness to return calculation can be performed using algorithms and/or artificial intelligence models. The models can also be utilized to supplement the algorithms and/or increase the confidence of the output of the algorithms. The likeliness of return calculation can be performed for individual users, individual work spaces, a physical space, and/or the like.

If a physical presence has not been detected at the work space at 302, the system identifies an availability status for the work space based upon the scheduling status of the work space and the fact that no physical presence has been detected at the work space at 304. If, on the other hand, a physical presence has been detected at the work space at 303, the system identifies an availability status for the work space based upon the scheduling status of the work space and the fact that a physical presence has been detected at the work space at 303. The availability status identifies a scheduling status and a physical presence status for a work space. In identifying the availability status, the system may input the scheduling status and the detected physical presence inputs into an algorithm and/or artificial intelligence model. The output of the algorithm and/or model may be the availability status.

As previously noted, the physical presence may not only be the current physical presence of users at the work space(s), but may include the time of last detection of a user at the work space(s). Thus, the availability status may indicate a time since the detection of the physical presence at the work space and the scheduling status of the work space. The availability status may also identify when the work space is next scheduled for use, or when a user might return to a work space. Thus, the availability status may identify how long the work space is estimated to be available until a user returns or until a user who had booked the work space is expected to be physically present within the physical space and expecting to use the work space. The availability status may also identify when the work space is scheduled to be available. If a work space is scheduled for a certain length of time, the system may identify when the length of time is set to expire and may then identify that the work space will be available at the expiration of that length of time. It should be noted, as previously discussed, that the system may also take into account information received from different sensors to identify when a work space may become available, how long a work space is expected to be available for, and/or the like.

In identifying the availability status of a work space, the system may also take into account physical presences detected at other work spaces in the area of the target work space. For example, if the work space is part of a cluster of work spaces, the system may also detect physical presences at the other work spaces in the cluster of work spaces. As an example, if a cluster of four work spaces has been virtually booked for four users, the system may detect physical presences at all four work spaces instead of a single of the four work spaces. This way, even if only three of the users who were scheduled for the cluster of work spaces are physically present, the system will not identify the fourth work space as available for a different user who is not a part of the four users who had booked the cluster of work spaces.

In identifying the availability status, the system may take into account the likeliness to use and likeliness to return calculations. This may result in, for example, an availability status that indicates that the work space has been booked, but the user who booked the work space is likely to not use the work space. As another example, the availability status may indicate that the work space is booked for a time in the future and the user is likely to want to use the work space. As another example, the availability status may indicate that the work space was being used by a user who is likely to return at a particular time in the future. Thus, the availability status may identify not only whether a work space is currently being used or has currently been booked, but how long the work space might be available for or how long before the work space might be available as identified, at least in part, based upon the likeliness to use and likeliness to return scores. The availability status can influence the ranking and recommendations made by the system for a work space to be utilized by the user.

While a single work space has been discussed, this is only for ease of readability. In practice, the system will generally identify an availability status for more than one work space. Thus, for each work space, the system identifies the availability status utilizing the aforementioned steps. However, the system may or may not identify the availability status for all work spaces within a physical space. Thus, the system may identify the availability status for a subset of the work spaces within the physical space. The subset may include a single work space, may include all work spaces within the physical space, or may include any number of work spaces between one and all.

At 305, the system displays, on a display device, the availability status of the at least a subset of the at least one work space. In other words, the system displays the availability status of the work space(s). As previously discussed, the displaying may include generating or providing instructions to display or transmitting instructions to display information. The availability status can be displayed on any type of display device, either one directly accessible by a user, for example, a device carried or assigned to a particular user, or by all users, for example, a device located within the physical space. It should be noted that regardless of the device or display that it utilized to display the availability status, the device or display may not be solely dedicated to the work space availability system. In other words, these devices or displays may be utilized to perform other tasks or functions and the work space availability system may simply be only one function performed by the device or display. Thus, as previously discussed, the device or display may receive instructions from the work space availability system to display the desired information, may include components that perform more of the functions of the work space availability system, may communicate with other devices that perform functions of the work space availability system, and/or the like.

As an example of utilizing a device of the user or assigned to the user, the user may have an augmented reality headset. As the user looks at the physical space through the augmented reality headset, the work space availability system, or an application thereof, may overlay the availability status of the work space(s) within the physical space on the headset, thereby allowing the user to look at work spaces within the physical space and see the availability status of the work space(s) on the headset. If a user is not looking at a particular work space that the system has identified as a good possibility for the user, the system may provide instructions to display graphics on the headset that would indicate to the user to look in a particular direction or that a recommended work space is in a particular direction, for example, arrows indicating a particular direction of the work space, a pop-up indicating a location or identifier of a recommended work space, blinking lights indicating a direction, and/or the like. Instead of providing a visual indication, the system could also provide a non-visual indication, for example, an audio output indicating a direction or location of a work space, a haptic output indicating a direction or location of a work space, and/or the like. The visual and/or non-visual indications can also be provided on other devices and/or displays, not only augmented reality headsets or other headsets.

As another example, the user may have a smart phone, tablet, laptop computer, or other portable information handling device. The user may access the work space availability application or graphical user interface and be presented with a visualization (e.g., map, three-dimensional model, digital twin, etc.) of the physical space. Overlaid on the visualization may be the availability status for the work spaces within the physical space. While an overlay has been discussed, it should be noted that this is not the only technique for displaying the work space availability status to a user. For example, the system could display a listing of work spaces with an availability status next to the work spaces. As another example, the system could display a calendar for each work space with an availability status included in the calendar listing for a work space. Other work space availability display layouts are contemplated and possible. Additional information may also be included with the availability status, for example, information related to user preferences, information related to a location or directions to the work space, and/or the like.

As an example of utilizing a device located within the physical space, the physical space may include a display or monitor that has a visualization (e.g., map, three-dimensional model, a digital twin, etc.) of the physical space. On the visualization, the system may display the availability status of the work spaces within the physical space. The display or monitor may also allow for user input that allows a user to change the visualization to other locations within the physical space or to select a specific work space or work spaces to display the availability status of the chosen area or selected work space or work spaces. As another example, the physical space may have an information handling device that is specifically dedicated to the physical space, for example, a personal computer system, a workstation, a dedicated laptop computer, a dedicated tablet, and/or the like, that the user can access to see the availability status of the work spaces within the environment.

The availability status that is displayed, or included in the display instructions, may include different information. In addition to the information identified from the scheduling application and the information gleaned from the sensor information regarding a physical presence, the system may rank work spaces and/or recommend work spaces for the user. The ranking or recommendations may be based upon the information identified from the scheduling application and the information regarding the physical presence of users. Thus, work spaces that are not booked, either currently or for a predetermined length of time, and have not had users detected may be ranked higher or recommended more for use than work spaces that are booked and/or have users detected. Since work spaces may be booked at different times or users may be detected at different times, the recommendations and rankings may change based upon a length of time until the next booking, the length of time until a room is no longer booked, a length of time since the last detection of users, and/or the like. Thus, for example, the longer the time since the last detection of users may increase the ranking of a work space. As another example, a work space whose booking is about to expire may have a higher ranking than a work space whose booking is about to begin.

As could be understood, the ranking and recommending could get complicated based upon the number of factors that can change the ranking. Thus, the system may employ an artificial intelligence model to provide a more accurate output, including a more accurate ranking and/or recommendation. The model can be trained using historical information and the trained model can then be deployed to make rankings and/or recommendations. As more information is gathered, the model can become more accurate over time. Additionally, instead of solely using a model for the ranking and/or recommendations, the system could make a ranking and/or recommendation and then utilize a model to increase the confidence of the ranking and/or recommendation. Thus, the model could be used to supplement the output generated by the system without the model.

In displaying the availability status, the system may also receive input from the user. For example, if the user needs a work space with particular capabilities or features, the user may indicate to the system what capabilities or features are desired by the user. For example, the user may indicate they would like a corner work space, a work space further away from other users, a work space that has dual monitors, a work space near a printer, a work space that can support a particular number of users together, a work space that has a particular type of work space surface or chair type, and/or the like. This input can be used by the system to filter the work spaces and provide a recommendation to the user of a work space that the user should utilize.

Instead of providing the filtering information every time, the user could set a user profile that includes preferred capabilities or features or a preferred work space. The system could then access the user profile when displaying the work space availability information and providing a recommendation regarding a work space for the user. If the user provides input, either manually or through the user profile, the system can identify work spaces and, when displaying the work spaces, may identify the capabilities or preferences provided by the work space that match the input of the user. Alternatively, or additionally, when displaying the work spaces, the system may identify which capabilities or preferences are not met by the work space.

The system may also provide additional information related to the availability of a work space. Rather than simply identifying whether the work space is booked or users have been detected at the space, the system can also identify if anyone has been looking at a space, for example, through the scheduling application. For example, if a user has been looking at work spaces having a particular configuration through the scheduling application and another user enters the physical space looking for a work space, the system can notify the user who has entered the physical space that other users are looking at certain work spaces or work spaces having a particular configuration. As another example, users could do a virtual walkthrough of a physical space before actually being in the physical space. The information regarding the work spaces that a user has viewed on the virtual walkthrough can be saved by the system. For a user who physically enters a physical space, the user can be notified that users were looking at a specific work space or types of work spaces. Similarly, the system can indicate that certain work spaces have not been viewed, either virtually or through the scheduling application, by any users for a particular length of time. This may provide a user with an idea that the space may still be open if the user physically enters the space.

Other information that the system may provide includes information related to how long another user might utilize a work space. For example, if a particular user is looking at a work space and has a meeting booked for a later time, the system may recognize that user will only use the work space for the time period before the meeting. Thus, the rankings and recommendations may be made based upon information gleaned from a user who may have been virtually looking at a work space or looking at a work space through the scheduling application. It should be noted that the system can identify other information and provide this to the user also. In other words, the above-mentioned information is merely utilized for illustrative purposes and is not intended to be limiting.

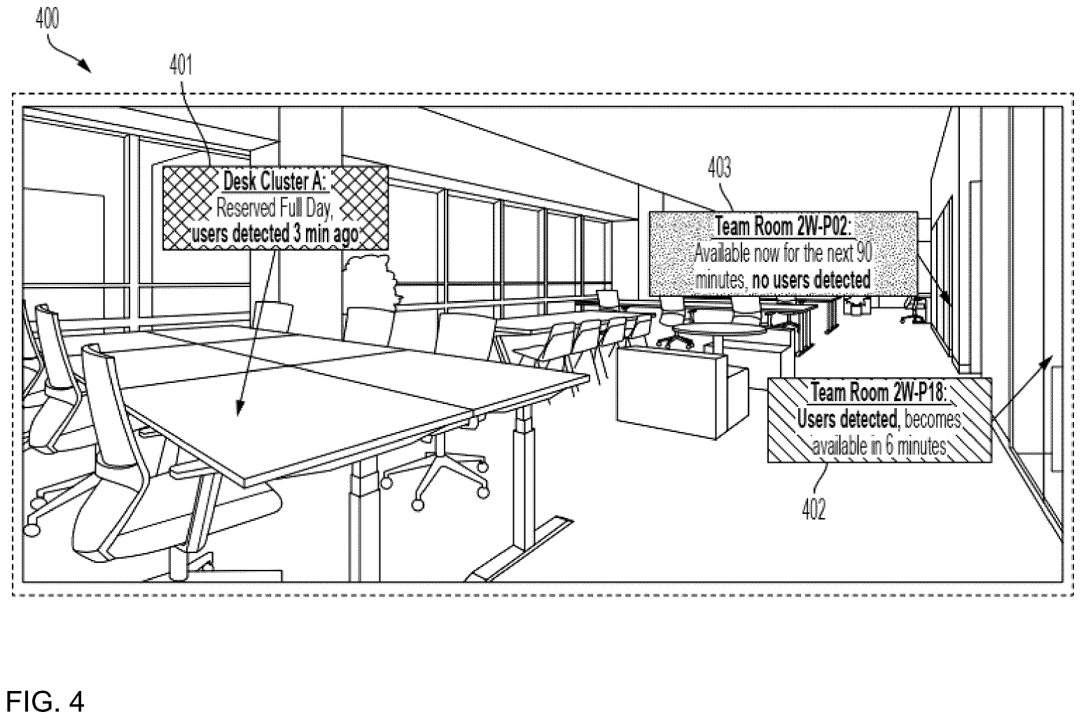

FIG. 4 illustrates an example graphical user interface 400 that may be displayed on a display device. As illustrated, a visualization of the physical space including work spaces is displayed. Overlaid upon the visualization of the physical space are three example availability status indicators 401, 402, and 403. The system has identified, via the scheduling application, that desk cluster A has been reserved for the full day. Additionally, the system has detected, utilizing one or more sensors, the physical presence of users 3 minutes ago. Thus, the system has provided a notification 401 to the user indicating the availability status as reserved and the physical presence of users being detected 3 minutes ago. The system has identified, via the scheduling application, that Team Room 2 W-P18 has been booked and has detected, via sensors, that users are currently present within the room. Via the scheduling application, the system has identified that the booking of the room expires in 6 minutes. Thus, the system has provided a notification 402 to the user indicating the availability status as reserved and the physical presence of users is currently detected, but that the booking expires in 6 minutes. Thus, the room may become available in the next 6 minutes. The system has identified, via the scheduling application, that Team Room 2 W-P02 is not currently booked and is not booked for the next 90 minutes. Additionally, via the sensors, the system has identified that the physical presence of users has not been detected. Accordingly, the system has provided a notification 403 to the user indicating the availability status as available for the next 90 minutes and no users have been detected.

As illustrated in FIG. 4, the notifications may be color coded or may have some other attribute that identifies a ranking or recommendation for a work space for a user. The notification 401 has an attribute (e.g., color, shading, border type, font type, ranking phrase (e.g., “highest ranking,” “lowest ranking,” “ranked 3/3,” “1 out of 3,” etc.), recommendation phrase (e.g., “most recommended,” “recommended 3/3,” “least recommended,” “do not recommend,” etc.), flashing icon or graphic, etc.) that indicates it is the least recommended or the worst choice for the user, since it has been booked for the full day and users were detected recently. The notification 402 has an attribute that indicates it is second choice or second recommended room for the user, since the room should be available in 6 minutes. The notification 403 has an attribute that indicates it is the best choice or most recommended for the user because it is available for the next 90 minutes and no users have been detected.

While the described system has been described as providing real-time or proactive information to a user attempting to locate a work space to utilize, the system can also provide retroactive information to a user. The system is able to store all the information it has identified in a database or other data storage location. Such information includes not only what work spaces were recommended to a user, but also what work spaces were chosen by a user and other information that is captured while the user is utilizing the work space. For example, the system may identify what users were utilizing the same work space, what users were in work spaces near the user, what time a work space was utilized, what day a work space was utilized, what information was discussed while using the work space, and/or the like. In other words, the system can store, within the database or data storage location, information related to the physical presence of the user at the work space and also information captured by sensors while the user is at the work space. All of this information can be stored in the data storage location of the system and can then be later accessed by the user.

When a user wants to know something related to their time at the work space, the user can query the system to request information related to the activities occurring in the physical space. The system can query the data storage location utilizing the query and return a response to the query to the user. For example, the user may query the system to identify a person the user was working with at a particular day and/or time. As another example, the user may query the system to identify what work space the user was utilizing at a particular day and/or time. As another example, the user may query the system to identify what work space the user was utilizing when working with a particular person or when discussing a particular topic. As another example, the user may query the system to identify the most frequent work space the user utilizes. Thus, the user may query the database not for exact information that is stored within the database. Rather, the system may have to extrapolate the information requested from the information stored within the database. In other words, while the system may store sensor information and other information directly captured, the query may request information that requires the system to analyze the stored information and extrapolate the requested information from the stored information.

As could be understood, the different types and numbers of queries that can be provided to the system and a response returned can be vast and vary greatly. Thus, these are merely illustrative examples.

As an overall non-limiting example of the described system, a user enters a physical space having different types of work spaces including desk clusters, individual desks, meeting rooms, and offices. The user may access an information handling device, either one assigned to the user or one located within the physical space, to identify a work space that the user can utilize for the next hour before a scheduled meeting. The user already has a profile that has preferences and capabilities for the work spaces that are recommended to the user. The system identifies those work spaces that are booked through the scheduling application and also identifies those work spaces where users have been detected. Based upon this information and the information contained in the user profile, the system identifies the availability status of work spaces within the physical space, particularly the availability status of these work spaces for the next hour. After identifying those work spaces which are available for the next hour and filtering them based upon the user profile, the system displays an output indicating the availability status of work spaces and also recommending particular work spaces for the user.

As another overall non-limiting example of the described system, a user may occupy work space B when the user is working with Abigail on a Thursday. During the time working with Abigail, the topic of refinishing a driveway comes up and Abigail recommends a company to the user. After both the user and Abigail have left the work spaces, Abigail sends the user a message saying to meet at the same work space on Thursday at 9 am. The user does not remember which work space they were utilizing when working with Abigail. Accordingly, the user accesses the system and provides a query “What work space was I using when working with Abigail on Thursday?” The system utilizes the query to query the data storage location and return a response to the query. In this example, the response is “Work Space B.” While providing the query, the user remembers that Abigail recommended a driveway refinishing company, but has forgotten the name of the company. The user provides another query to the system, “What is the name of the driveway refinishing company Abigail recommended?” The system queries the data storage location and returns a response to the query.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
identifying, from a scheduling application, a scheduling status of at least one work space within a physical space;
detecting, utilizing sensors within the physical space, a physical presence of users at the at least one work space;
identifying, based upon the scheduling status and the physical presence, an availability status of each of the at least one work space; and
transmitting an instruction to display, on a display device, the availability status of each of the at least a subset of the at least one work space.

2. The method of claim 1, wherein the availability status indicates a time since the detection of the physical presence at the at least one work space and the scheduling status of the at least one work space.

3. The method of claim 1, wherein the availability status identifies a time until the at least one work space will be available as identified from the scheduling status and the physical presence.

4. The method of claim 1, wherein the identifying the scheduling status comprises accessing a calendar application comprising scheduling status information associated with the physical space.

5. The method of claim 1, wherein the identifying the availability status comprises inputting the scheduling status and the detected physical presence inputs into an artificial intelligence model and receiving the availability status as an output from the artificial intelligence model.

6. The method of claim 1, wherein the displaying comprises displaying a recommendation of one of the at least a subset of the at least one work space for a user.

7. The method of claim 1, wherein the displaying comprises ranking the at least a subset of the at least one work space based upon the availability status.

8. The method of claim 1, further comprising storing, within a data storage location, information related to the physical presence of the user at the at least one work space and information captured by the sensors.

9. The method of claim 8, further comprising receiving a query requesting additional information related to activities occurring in the physical space and returning a response to the query by querying the data storage location with the query and extrapolating the additional information.

10. The method of claim 1, wherein the displaying comprises displaying the availability status as an overlay on a visualization of the physical space.

11. A system, the system comprising:
sensors within a physical space;
a display device;
a processor operatively coupled to the sensors and the display device;
a memory device that stores instructions that, when executed by the processor, causes the system to:
identify, from a scheduling application, a scheduling status of at least one work space within the physical space;
detect, utilizing the sensors within the physical space, a physical presence of users at the at least one work space;
identify, based upon the scheduling status and the physical presence, an availability status of each of the at least one work space; and
transmit an instruction to display, on the display device, the availability status of each of the at least a subset of the at least one work space.

12. The system of claim 11, wherein the availability status indicates a time since the detection of the physical presence at the at least one work space and the scheduling status of the at least one work space.

13. The system of claim 11, wherein the availability status identifies a time until the at least one work space will be available as identified from the scheduling status and the physical presence.

14. The system of claim 11, wherein the identifying the scheduling status comprises accessing a calendar application comprising scheduling status information associated with the physical space.

15. The system of claim 11, wherein the identifying the availability status comprises inputting the scheduling status and the detected physical presence inputs into an artificial intelligence model and receiving the availability status as an output from the artificial intelligence model.

16. The system of claim 11, wherein the displaying comprises displaying a recommendation of one of the at least a subset of the at least one work space for a user.

17. The system of claim 11, wherein the displaying comprises ranking the at least a subset of the at least one work space based upon the availability status.

18. The system of claim 11, further comprising storing, within a data storage location, information related to the physical presence of the user at the at least one work space and information captured by the sensors.

19. The system of claim 18, further comprising receiving a query requesting additional information related to activities occurring in the physical space and returning a response to the query by querying the data storage location with the query and extrapolating the additional information.

20. A product, the product comprising:
a computer-readable storage device that stores executable code that, when executed by a processor, causes the product to:
identify, from a scheduling application, a scheduling status of at least one work space within the physical space;
detect, utilizing sensors within the physical space, a physical presence of users at the at least one work space;
identify, based upon the scheduling status and the physical presence, an availability status of each of the at least one work space; and
transmit an instruction to display, on a display device, the availability status of each of the at least a subset of the at least one work space.
